(19) United States
(12) Patent Application Publication
(10) Pub. No.: US 2025/0219249 A1
(43) Pub. Date: Jul. 3, 2025

(54) SEPARATOR CO-COATED WITH ANODE AND CATHODE ACTIVE MATERIALS

(71) Applicant: Enovix Corporation, Fremont, CA (US)

(72) Inventor: Sabarinath Jayaseelan, San Jose, CA (US)

(21) Appl. No.: 18/400,383

(22) Filed: Dec. 29, 2023

(51) Int. Cl. H01M 50/46; H01M 4/66; H01M 10/04; H01M 50/406; H01M 50/497

(52) U.S. Cl. CPC H01M 50/46; H01M 4/662; H01M 10/0468; H01M 50/406; H01M 50/497

(57) ABSTRACT

Systems and methods are provided herein for generating wave pair segments for use in an electrode assembly. For example, a web of ionically permeable and electrically isolating separator material may be coated on a first side with anodically active material. The web may then be coated on a second side, opposite the first side, with cathodically active material. The web may then be cut into equally sized wave-pair segments. A web of cathode current collector material may be cut into a plurality of cathode current collectors and a web of anode current collector material may be cut into a plurality of anode current collectors. The wave-pair segments and current collectors may be interleaved to form an electrode assembly where the alignment between the anode and cathode is fixed.

### BACKGROUND

The present invention relates to electrode assemblies for use in energy storage devices such as secondary batteries.

### SUMMARY

Rocking chair or insertion secondary batteries are a type of energy storage device in which carrier ions, such as lithium, sodium, potassium, calcium or magnesium ions, travel between a cathode and an anode through an electrolyte. A “separator” may be used to separate the anode and cathode during assembly of the battery and during battery operation. Anode and cathode current collectors pool electric current from the respective active electrochemical electrodes and enable transfer of the current to the environment outside the battery. Currently, anodically active material is applied to anode current collector foils and cathodically active material is applied to cathode current collector foils to create anode webs and cathode webs. The anode webs and cathode webs are then diced (e.g., by laser) to generate populations of anode units and cathode units in which the active material is coated onto the current collectors.

There are a number of shortcomings related to secondary batteries and the process of making secondary batteries. For example, the application of the active material to the current collector foils requires that the foil be relatively thick in order to withstand the application process. The thickness of the foil increases the weight and volume of inactive materials, thereby decreasing the energy density of the battery. In another example, dicing the webs generates metallic particles (from the current collector material) that deposit on the active material, which introduces a high risk of damage to the battery (e.g., dendrite growth, electrical short circuits, thermal runaway, etc.). In another example, incorrect electrode alignment can lead to short circuits and failure of the battery.

Accordingly, techniques are disclosed herein for a system to coat cathodically active material on one side of a web of separator material and to coat anodically active material on the other side of the web of separator material. For example, the separator web with the co-coating of anodically active material relative to the cathodically active material may be cut into “wave pair” segments that can be interleaved with electrode current collectors and stacked in a stacking direction to form an electrode assembly in which anodes and cathodes cannot move relative to one another. The wave pair segments may be arranged so that similarly coated sides face one another, separated by current collectors. Thus, a second segment may be stacked relative to a first segment so that their anode sides face one another, with an anode current collector in physical contact with the anodically active material of both the first segment and the second segment. A third segment may be stacked in an alternate orientation so that the third segment's cathode side faces the cathode side of the second segment, with a cathode current collector in physical contact with the cathodically active material of both the second segment and the third segment. Additional segments may be stacked alternatingly, so that each cathode side faces a cathode side, and each anode side faces an anode side (except at the ends of the stack), with the appropriate current collectors (e.g., anode current collector or cathode current collector) interleaved at the appropriate locations. The stack of co-coated separators and current collectors forms an electrode assembly that can be used in three-dimensional secondary batteries.

Coating cathodically active material on one side of the web of separator material and coating anodically active material on the other side of the web of separator material ensures that the anodically active material is aligned with the cathodically active material, eliminating the risk of active material misalignment. Further, the current collector is no longer required to be of a minimum thickness in order to be strong enough to survive the active material application process. The resulting reduction in thickness reduces inactive component weights within the electrode assembly, which increases the energy density of the resulting battery. Further, since the active material is no longer applied to the current collectors, the current collectors can be diced without any metallic particles depositing on the active material. Any metallic particles that are generated when dicing the current collectors can be removed from the current collectors through a cleaning process prior to stacking. The reduction of the amount of metallic particles deposited on the active material decreases the risk of damage to the battery.

### BRIEF DESCRIPTION OF THE DRAWINGS

The present disclosure, in accordance with one or more various implementations, is described in detail with reference to the following drawings. The drawings are provided for purposes of illustration only and merely depict typical or example implementations. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a front view of a wave pair segment, in accordance with some implementations of the subject matter of the disclosure.

FIG. 2 is a cross section of a wave pair segment, in accordance with some implementations of the subject matter of the disclosure.

FIG. 3 is a front view of a stack of wave pair segments, cathode current collectors, and an anode current collector, in accordance with some implementations of the subject matter of the disclosure.

FIG. 4 is a front perspective view of a battery assembly having a cutaway portion revealing the internal structure of the battery, in accordance with some implementations of the subject matter of the disclosure.

FIG. 5 is an illustrative flowchart of a process for preparing an electrode assembly, in accordance with some implementations of the subject matter of the disclosure.

FIG. 6 is an illustrative flowchart of a process for preparing an electrode assembly, in accordance with some implementations of the subject matter of the disclosure.

### DETAILED DESCRIPTION

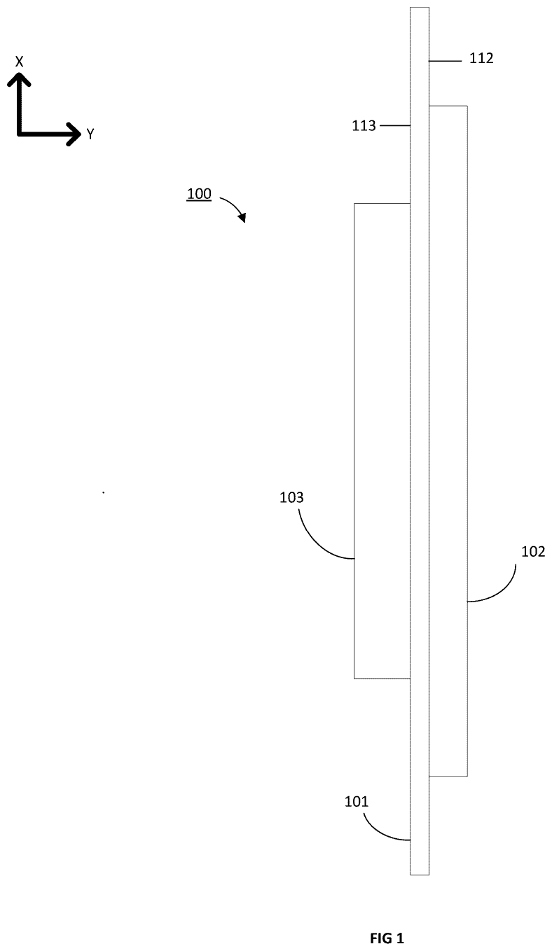

FIG. 1 is a front view of a first wave pair segment 100. The first wave pair segment 100 includes a first separator material layer 101, a first cathodically active material layer 103 and a first anodically active material layer 102. The first wave pair segment 100 may also be referred to as a co-coated separator element. “Separator material” may refer to material that is electrically insulating and ionically permeable. “Anode material” or “anodically active material” may refer to material suitable for use as a negative electrode of a secondary battery during discharge of the secondary battery. “Cathode material” or “cathodically active material” may refer to material suitable for use as a positive electrode of a secondary battery during discharge of the secondary battery.

The first cathodically active material layer 103 may be coated onto a first side 113 of the first separator material layer 101. The first anodically active material layer 102 may be coated onto a second side 112 of the first separator material layer 101. The co-coating of the active materials may ensure the alignment of the first anodically active material layer 102 and the first cathodically active material layer 103, thereby eliminating the risk of misalignment.

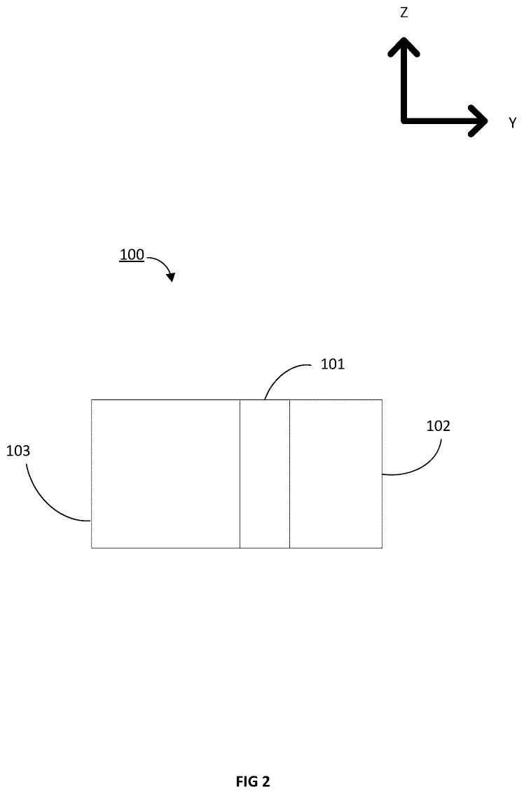

FIG. 2 is a cross-sectional view of the first wave pair segment 100. The first wave pair segment 100 includes the first separator material layer 101, the first cathodically active material layer 103, and the first anodically active material layer 102.

The first separator material layer 101 separates the cathodically active material from the anodically active material. The first separator material layer 101 may be made of electrically insulating but ionically permeable separator material. The first separator material layer 101 may include a microporous separator material that can be permeated with a non-aqueous electrolyte, as described below. For example, in some implementations, the microporous separator material includes pores having a diameter of at least 50 Angstroms (Å), more typically in the range of about 2,500 A, and a porosity in the range of about 25% to about 75%, more typically in the range of about 35% to 55%.

The material of the first separator material layer 101 may be selected from a wide range of material having the capacity to conduct carrier ions between the first anodically active material layer 102 and the first cathodically active material layer 103. For example, the first separator material layer 101 may be a microporous separator material that may be permeated with a liquid, non-aqueous electrolyte. Alternatively, the first separator material layer 101 may be a gel or solid electrolyte capable of conducting carrier ions between the first anodically active material layer 102 and the first cathodically active material layer 103.

In some implementations, the first separator material layer 101 may be a polymer-based electrolyte. Polymer electrolytes may be PEO-based polymer electrolytes, polymer-ceramic composite electrolytes, polymer-ceramic composite electrolytes, and polymer-ceramic composite electrolytes. In other implementations, the first separator material layer 101 may be an oxide-based electrolyte. Oxide-based electrolytes may be lithium lanthanum titanate (Li_{0.34}La_{0.56}TiO₃), Al-doped lithium lanthanum zirconate (Li_{6.24}La₃Zr₂Al_{0.24}O_{11.98}), Ta-doped lithium lanthanum zirconate (Li_{6.4}La₃Zr_{1.4}Ta_{0.6}O₁₂), and lithium aluminum titanium phosphate (Li_{1.4}Al_{0.4}Ti_{1.6}(PO₄)₃). In other implementations, the first separator material layer 101 may be a solid electrolyte. Solid electrolytes may be sulfide-based electrolytes such as lithium tin phosphorus sulfide (Li₁₀SnP₂Si₂), lithium phosphorus sulfide (β-Li₃PS₄), and lithium phosphorus sulfur chloride iodide (Li₆PS₅Cl_{0.9}I_{0.1}). In some implementations, the first separator material layer 101 may be a solid-state lithium ion conducting ceramic, such as a lithium-stuffed garnet.

In some implementations, the first separator material layer 101 is a microporous separator material comprising a particulate material and a binder, with the microporous separator material having a porosity (void fraction) of about 20 vol. %. The pores of the microporous separator material may have a diameter of at least 50 A and may fall within the range of about 250 A to about 2,500 A. The microporous separator material may have a porosity of less than 75%. In some implementations, the microporous separator material has a porosity (void fraction) of about 25 vol %. In some implementations, the microporous separator material may have a porosity of about 35-55%.

The binder for the microporous separator material may be selected from a wide range of inorganic or polymeric materials. For example, the binder may be an organic material selected from the group consisting of silicates, phosphates, aluminates, aluminosilicates, and hydroxides such as magnesium hydroxide, calcium hydroxide, etc. For example, the binder may be a fluoropolymer derived from monomers containing vinylidene fluoride, hexafluoropropylene, tetrafluoropropene, and the like. In other implementations, the binder may be a polyolefin such as polyethylene, polypropylene, or polybutene, having any of a range of varying molecular weights and densities. In other implementations, the binder may be selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In other implementations, the binder may be selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, and polyethylene oxide. In other implementations, the binder may be selected from the group consisting of acrylates, styrenes, epoxies, and silicones. In other implementations, the binder may be a copolymer or blend of two or more of the aforementioned polymers.

The particulate material made by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, the particulate material may have a conductivity for carrier ions (e.g., lithium) of less than 1×10⁻⁴ Siemens/cm (S/cm). By way of further example, the particulate material may have a conductivity for carrier ions of less than 1×10⁻⁵ S/cm. By way of further example, the particulate material may have a conductivity for carrier ions of less than 1×10⁻⁶ S/cm. Particulate materials may be particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in some implementations, the particulate material may be a particulate oxide or nitride such as TiO₂, SiO₂, Al₂O₃, GeO₂, B₂O₃, Bi₂O₃, BaO, ZnO, ZrO₂, BN, Si₃N₄, and Ge₃N₄. See, for example, P. Arora and J. Zhang, “Battery Separators” Chemical Reviews 2004, 104, 4419-4462, which is hereby incorporated by reference herein in its entirety. In some implementations, the particulate material may have an average particle size of about 20 nanometer (nm) to 2 micrometers (μm), more typically 200 nm to 1.5 μm. In some implementations, the particulate material may have an average particle size of about 500 nm to 1 μm.

In an alternative implementation, the particulate material of the microporous separator material may be bound by techniques such as sintering, binding, curing, etc., while maintaining the void fraction desired for electrolyte ingress to provide the ionic conductivity for the functioning of the battery.

The microporous separator material of the first separator layer 101 may be permeated with a non-aqueous electrolyte suitable for use as a secondary battery electrolyte. In some implementations, the non-aqueous electrolyte is a lithium salt and/or mixture of salts dissolved in an organic solvent and/or solvent mixture. Lithium salts may be inorganic lithium salts such as LiClO₄, LiAsF₆, LiCl, and LiBr; and organic lithium salts such as LiB(C₆H₅)₄, LiN(SO₂CF₃)₂, LiN(SO₂CF₃)₃, LiNSO₂CF₃, LiNSO₂CF₅, LiNSO₂C₄F₉, LiNSO₂C₅F₁₁, LiNSO₂C₆F₁₃, and LiNSO₂C₇F₁₅. Organic solvents to dissolve the lithium salt may be cyclic esters, chain esters, cyclic ethers, and chain ethers. Specific examples of the cyclic esters include propylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

The first separator material layer 101 may have a thickness of about 4 μm. For example, in some implementations, the first separator material layer 101 may have a thickness of about 8 μm. By way of further example, in some implementations, the first separator material layer 101 may have a thickness of about 12 μm. By way of further example, in some implementations, the first separator material layer 101 may have a thickness of about 15 μm. In some implementations, the first separator material layer 101 may have a thickness of up to 25 μm, up to 50 μm, or any other suitable thickness. In some implementations, the first separator material layer 101 may have a thickness of less than 12 μm or less than 10 μm.

In some implementations, the cathodically active material may be selected from transition metal oxides, transition metal sulfides, transition metal nitrides, lithium-transition metal oxides, lithium-transition metal sulfides, transition-metal phosphates, lithium-transition-metal phosphates, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanides, actinides, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathode active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Coz)O₂, and combinations thereof.

In some implementations, the first cathodically active material layer 103 has a thickness of about 20 μm. In other implementations, the first cathodically active material layer 103 has a thickness of about 40 μm. In other implementations, the first cathodically active material layer 103 has a thickness of about 60 μm. By way of further example, in some implementations, the first cathodically active material layer 103 has a thickness of about 100 μm. In some implementations, the cathodically active material layer 103 has a thickness of less than 90 μm and/or less than 70 μm.

Anodically active materials may be carbon materials such as graphite and soft or hard carbons, or graphene (e.g., single-walled or multi-walled carbon nanotubes), or any of a range of metals, semi-metals, alloys, oxides, nitrides and compounds capable of intercalating lithium or forming an alloy with lithium. Specific examples of the metals or semi-metals that may be used as the anode material include graphite, tin, lead, magnesium, aluminum, boron, gallium, silicon, Si/C composites, Si/graphite blends, silicon oxide (SiOₓ), porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In some implementations, the anodically active material may be aluminum, tin, or silicon, or an oxide thereof, a nitride thereof, a fluoride thereof, or other alloy thereof. In some implementations, the anodically active material may be silicon or an alloy or oxide thereof.

In some implementations, the first anodically active material layer 102 may has a thickness of about 10 μm. In other implementations, the first anodically active material layer 102 has a width in the Y-axis direction of about 40 μm. In some implementations, the first anodically active material layer 102 has a width of about 80 μm. In some implementations, the first anodically active material layer 102 has a width of about 120 μm. In some implementations, the first anodically active material layer 102 has a width of less than 60 μm and/or less than 30 μm.

The first wave pair segment 100 may be cut from a web of co-coated separator material. For example, a web of separator material may be coated on a first side with anodically active material. The web of separator material may then be coated on a second side, opposite the first side, with cathodically active material. The active material may be coated onto the web of separator material by any method of chemical vapor deposition (CVD), physical vapor deposition (PVD), atomic layer deposition (ALD), slot-die coating, comma coating, sputter coating, or any other method known in the art.

The web of co-coated separator material may be divided into a plurality of wave pair segments by cutting the web into equally sized wave pair segments. In some implementations, the web is inserted into a slitting machine in which the web is slit into a plurality of wave pair segments. The cutting process may be carried out by one or more blades. In some implementations, the web is laser diced to generate the plurality of wave pair segments.

The wave pair segments, with the co-coating of anodically active material relative to the cathodically active material, may be interleaved with electrode current collectors and stacked in a stacking direction to form an electrode assembly in which anodes and cathodes cannot move relative to one another.

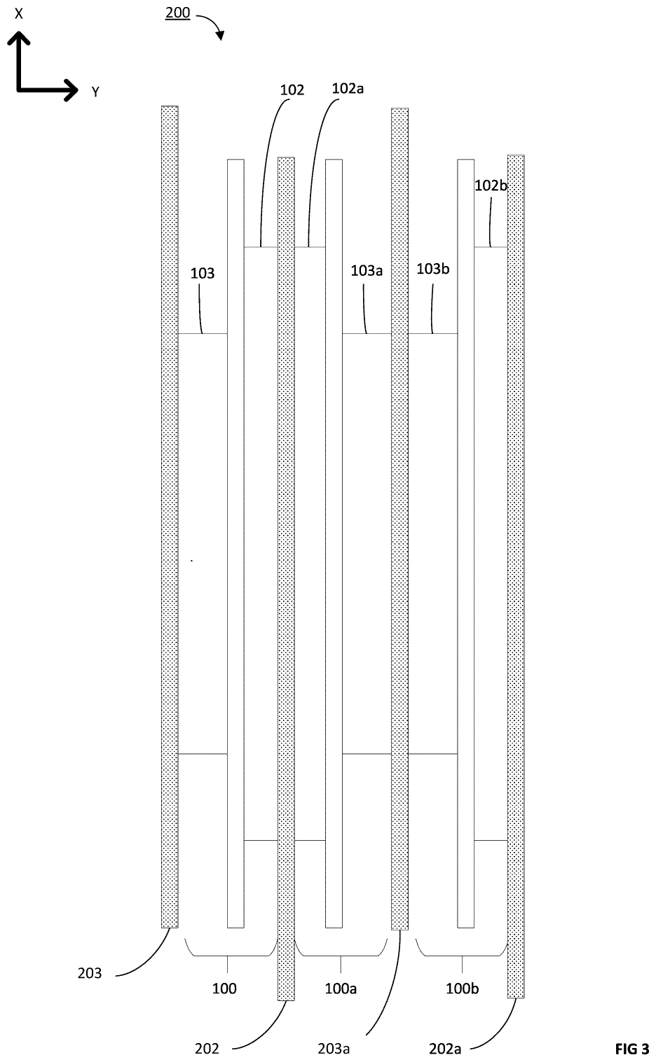

FIG. 3 is a front view of an electrode assembly 200, which includes the first wave pair segment 100, a second wave pair segment 100a, a third wave pair segment 100b, a first anode current collector 202, a second anode current collector 202a, a first cathode current collector 203, and a second cathode current collector 203a. The electrode assembly 200 may also be referred to as an electrode structure. “Anode current collector” and “cathode current collector” may refer to a current collector of a secondary battery that is used to pool electric current from the respective active electrochemical electrodes and enable transfer of the current to an environment outside the battery.

The first cathodically active material layer 103 of the first wave pair segment 100 is aligned with and in physical contact with the first cathode current collector 203. The first anodically active material layer 102 of the first wave pair segment 100 is aligned with and in physical contact with the first anode current collector 202. A second anodically active material layer 102a of the second wave pair segment 100a is aligned with and in physical contact with the first anode current collector 202. A second cathodically active material layer 103a of the second wave pair segment 100a is aligned with and in physical contact with the second cathode current collector 203a. A third cathodically active material layer 103b of the third wave pair segment 100b is aligned with and in physical contact with the second cathode current collector 203a. The third anodically active material layer 102b of the third wave pair segment 100b is aligned with and in physical contact with the second anode current collector 202a. Any suitable number of wave pair segments, anode current collectors, and cathode current collectors may be present in the electrode assembly 200, so long as the components of the electrode assembly 200 are oriented in a way that reflects the orientation of the first wave pair segment 100, the second wave pair segment 100a, the third wave pair segment 100b, the first anode current collector 202, the second anode current collector 202a, the first cathode current collector 203, and the second cathode current collector 203a, as described.

The first cathode current collector 203 may be aluminum, nickel, cobalt, titanium, and tungsten, or alloys thereof, or any other material suitable for use as a cathode current collector. The first current collector 203 may have an electrical conductivity of about 103 Siemens/cm. In some implementations, the first cathode current collector 203 has a conductivity of about 104 Siemens/cm. In some implementations, the first cathode current collector 203 has a conductivity of about 105 Siemens/cm. The first cathode current collector 203 may be a metal such as aluminum, carbon, chromium, gold, nickel, NiP, palladium, platinum, rhodium, ruthenium, an alloy of silicon and nickel, titanium, or a combination thereof (see “Current collectors for positive electrodes of lithium-based batteries” by A. H. Whitehead and M. Schreiber, Journal of the Electrochemical Society, 152(11) A2105-A2113 (2005), which is hereby incorporated by reference herein in its entirety). In some implementations, the first cathode current collector 203 is a gold or an alloy thereof such as gold silicide. In some implementations, the first cathode current collector 203 is nickel or an alloy thereof such as nickel silicide.

The first anode current collector 202 may be a conductive material such as copper, carbon, nickel, stainless-steel, cobalt, titanium, and tungsten, and alloys thereof, or any other material suitable as an anode current collector layer. The first anode current collector 202 may have an electrical conductivity of about 103 Siemens/cm. In some implementations, the first anode current collector 202 has a conductivity of about 104 Siemens/cm. In some implementations, the first anode current collector 202 has a conductivity of about 105 Siemens/cm.

The first cathode current collector 203 may be cut from a web of cathode current collector material. The web of cathode current collector material may be divided into equally sized cathode current collectors. In some implementations, the web is inserted into a slitting machine in which the web is slit into a plurality of cathode current collectors. The cutting process may be carried out by one or more blades. In some implementations, the web is laser diced to generate a plurality of cathode current collectors.

The cutting of the web of cathode current collector material may generate metallic particles that adhere to the plurality of cathode current collectors. Each cathode current collector in the plurality of cathode current collectors may undergo a cleaning process to remove metallic particles that may adhere to the cathode current collectors, thereby reducing the number of metallic particles that may be present in the electrode assembly 200.

The first anode current collector 202 may be cut from a web of anode current collector material. The web of anode current collector material may be divided into equally sized anode current collectors. In some implementations, the web is inserted into a slitting machine in which the web is slit into a plurality of anode current collectors. The cutting process may be carried out by one or more blades. In some implementations, the web is laser diced to generate a plurality of anode current collectors.

The cutting of the web of anode current collector material may generate metallic particles that adhere to the plurality of anode current collectors. Each anode current collector in the plurality of anode current collectors may undergo a cleaning process to remove metallic particles that may adhere to the anode current collectors, thereby reducing the number of metallic particles that may be present in the electrode assembly 200.

In some implementations, the first anode current collector 202, has an electrical conductance that is substantially greater than the electrical conductance of the first anodically active material layer 102. In some implementations, the ratio of the electrical conductance of the first anode current collector 202 to the electrical conductance of the first anodically active material layer 102 is at least 100:1. In some implementations, the ratio of the electrical conductance of the first anode current collector 202 to the electrical conductance of the first anodically active material layer 102 is at least 500:1. In some implementations, the ratio of the electrical conductance of the first anode current collector 202 to the electrical conductance of the first anodically active material layer 102 is at least 1000:1. In some implementations, the ratio of the electrical conductance of the first anode current collector 202 to the electrical conductance of the first anodically active material layer 102 is at least 5000:1. In some implementations, the ratio of the electrical conductance of the first anode current collector 202 to the electrical conductance of the first anodically active material layer 102 is at least 10,000:1.

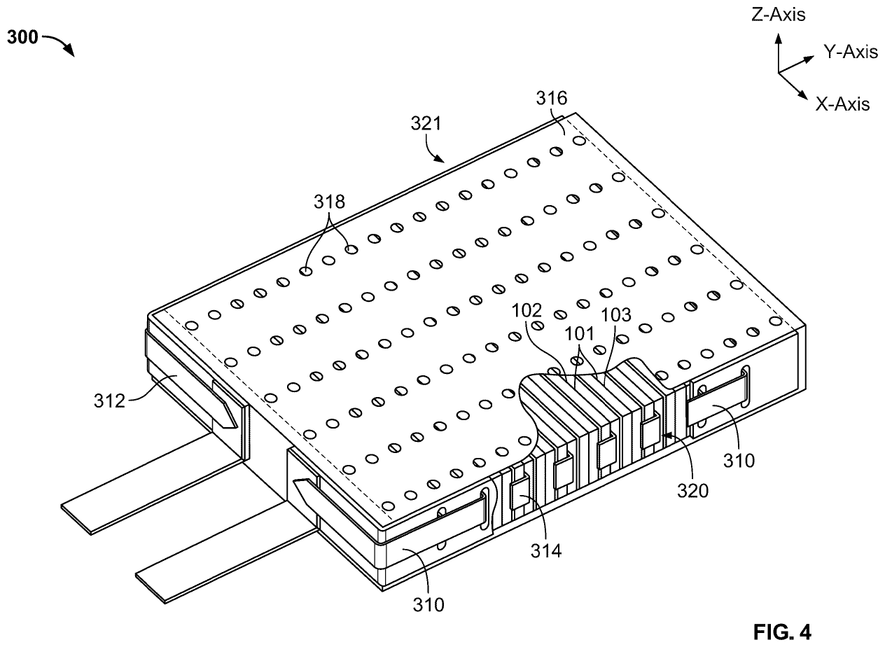

FIG. 4 is a front perspective view of one suitable implementation of a secondary battery 300 having a portion exposed showing some of the internal structures of the secondary battery 300. In some implementations, the internal structure of battery assembly 300 may include the first anodically active material layer 102, the first separator material layer 101, and the first cathodically active material layer 103. It should be appreciated that in suitable implementations of the present disclosure, any number of anodically active material layers, separator material layers, and cathodically active material layers may be used. For example, there may be between 1 and 200 wave segments in the secondary battery 300. In some implementations, the internal structure of the battery assembly 300 may be the electrode assembly 200 described in FIG. 2. Anode current collectors may be electrically coupled with one or more electrode tabs 314 on a first side 320 or a second side 321 of the secondary battery 300. Cathode current collectors may also be electrically coupled with one or more electrode tabs 314 on the first side 320 or the second side 321 of the secondary battery 300.

Referring to FIG. 4, the secondary battery 300 comprises a first busbar 310 and a second busbar 312 that are in electrical contact with the first anodically active material layer 102 and the first cathodically active material layer 103, via one or more electrode tabs 314. The electrode tabs 314 are only visible on the first side 320 of the secondary battery 300 in FIG. 4, although a different set of the electrode tabs 314 are present on the second side 321 of the secondary battery. The electrode tabs 314 on the first side 320 of the secondary battery 300 are electrically coupled with the first busbar 310, which may be referred to as an anode busbar. The electrode tabs 314 on the second side 321 of the secondary battery 300 (not visible in FIG. 4) may be electrically coupled to the second busbar 312, which may be referred to as a cathode busbar. In some implementations, the first busbar 310 may be electrically coupled with a first electrical terminal of the secondary battery 300. When the first busbar 310 is an anode busbar for the secondary battery 300, the first electrical terminal may be a negative terminal for the secondary battery 300. Further in this implementation, the second busbar 312 may be electrically coupled with a second electrical terminal of the secondary battery 300. When the second busbar 312 is a cathode busbar for the secondary battery 300, the second electrical terminal may be a positive terminal for the secondary battery 300.

In some implementations, a casing 316, which may be referred to as a constraint, may be applied over one or both of the X-Y surfaces of the secondary battery 300. In the implementation shown in FIG. 4, the casing 316 includes a plurality of perforations 318 to facilitate distribution or flow of an electrolyte solution once the secondary battery 300 has been fully assembled. In some implementations, the casing 316 may be stainless steel, such as SS301, SS316, 440C or 440C hard. In other implementations, the casing 316 may be aluminum (e.g., aluminum 7075-T6, hard H18, etc.), titanium (e.g., 6A1-4V), beryllium, beryllium copper (hard), copper (O₂ free, hard), nickel, other metals or metal alloys, composite, polymer, ceramic (e.g., alumina (e.g., sintered or Coorstek AD96), zirconia (e.g., Coorstek YZTP), yttriastabilizedzirconia (e.g., ENrG E-Strate®)), glass, tempered glass, polyetheretherketone (PEEK) (e.g., Aptiv 1102), PEEK with carbon (e.g., Victrex 90HMF40 or Xycomp 1000-04), polyphenylene sulfide (PPS) with carbon (e.g., Tepex Dynalite 207), polyetheretherketone (PEEK) with 30% glass (e.g., Victrex 90HMF40 or Xycomp 1000-04), polyimide (e.g., Kapton®), E Glass Std Fabric/Epoxy 0 deg, E Glass UD/Epoxy 0 deg, Kevlar Std Fabric/Epoxy 0 deg, Kevlar UD/Epoxy 0 deg, Carbon Std Fabric/Epoxy 0 deg, Carbon UD/Epoxy 0 deg, Toyobo Zylon® HM Fiber/Epoxy, Kevlar 49 Aramid Fiber, S Glass Fibers, Carbon Fibers, Vectran UM LCP Fibers, Dyneema, Zylon, or other suitable material.

In some implementations, the casing 316 may be a sheet having a thickness in the range of about 10 to about 100 μm. In some implementations, the casing 316 may be a stainless-steel sheet (e.g., SS316) having a thickness of about 30 μm. In other implementations, the casing 316 may be an aluminum sheet (e.g., 7075-T6) having a thickness of about 40 μm. In other implementations, the casing 316 may be a zirconia sheet (e.g., Coorstek YZTP) having a thickness of about 30 μm. In other implementations, the casing 316 may be an E Glass UD/Epoxy 0 deg sheet having a thickness of about 75 μm. In other implementations, the casing 316 may be 12 μm carbon fibers at >50% packing density.

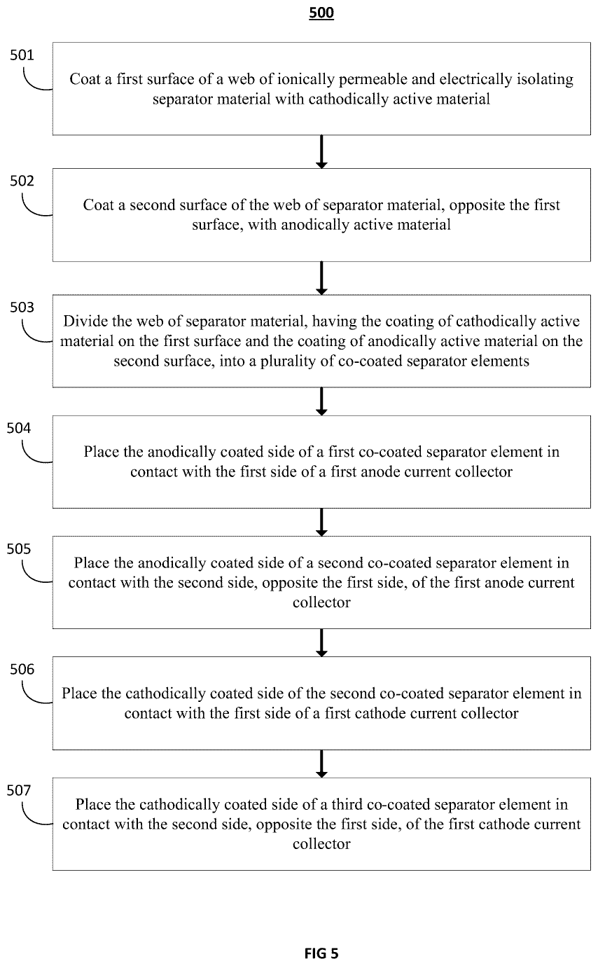

FIG. 5 is an illustrative flowchart of a process 500 for preparing an electrode assembly, in accordance with some implementations of the disclosure.

At 501 through 503, a plurality of co-coated separator elements are generated. At 501, a first surface of a web of ionically permeable and electrically isolating separator material is coated with cathodically active material. At 502, a second surface of the web of separator material, opposite the first surface, is coated with anodically active material. At 503, the web of separator material, having the coating of cathodically active material on the first surface and the coating of anodically active material on the second surface, is divided into a plurality of co-coated separator elements.

At 504 through 507, an electrode assembly is prepared. At 504, the anodically coated side of a first co-coated separator element is placed in contact with the first side of a first anode current collector. At 505, the anodically coated side of a second co-coated separator element is placed in contact with the second side, opposite the first side, of the first anode current collector. At 506, the cathodically coated side of the second co-coated separator element is placed in contact with the first side of a first cathode current collector. At 507, the cathodically coated side of a third co-coated separator element is placed in contact with the second side, opposite the first side, of the first cathode current collector. 504 through 507 may be repeated for any suitable number of co-coated separator elements, anode current collectors, and cathode current collectors in order to build a suitably sized electrode structure for use in a secondary battery.

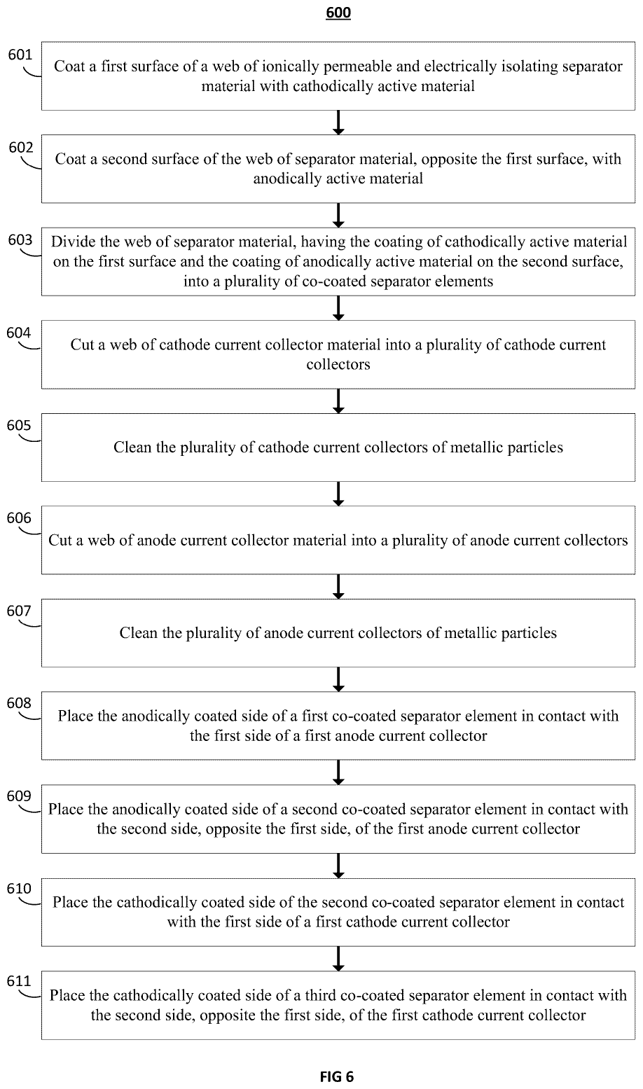

FIG. 6 is an illustrative flowchart of a process 600 for preparing an electrode assembly, in accordance with some implementations of the disclosure.

At 601 through 603, a plurality of co-coated separator elements are generated. At 601, a first surface of a web of ionically permeable and electrically isolating separator material is coated with cathodically active material. At 602, a second surface of the web of separator material, opposite the first surface, is coated with anodically active material. At 603, the web of separator material, having the coating of cathodically active material on the first surface and the coating of anodically active material on the second surface, is divided into a plurality of co-coated separator elements.

At 604 through 605, a plurality of cathode current collectors are generated. At 604, a web of cathode current collector material is cut into a plurality of cathode current collectors. At 605, metallic particles are removed from each cathode current collector of the plurality of cathode current collectors by a cleaning process.

At 606 through 607, a plurality of anode current collectors are generated. At 606, a web of anode current collector material is cut into a plurality of anode current collectors. At 607, metallic particles are removed from each anode current collector of the plurality of anode current collectors by a cleaning process.

At 608 through 611, an electrode assembly is prepared. At 608, the anodically coated side of a first co-coated separator element is placed in contact with the first side of a first anode current collector. At 609, the anodically coated side of a second co-coated separator element is placed in contact with the second side, opposite the first side, of the first anode current collector.

At 610, the cathodically coated side of the second co-coated separator element is placed in contact with the first side of a first cathode current collector. At 611, the cathodically coated side of a third co-coated separator element is placed in contact with the second side, opposite the first side, of the first cathode current collector. 608 through 611 may be repeated for any suitable number of co-coated separator elements, anode current collectors, and cathode current collectors in order to build a suitably sized electrode assembly for use in a secondary battery.

In some implementations, one or more co-coated separator elements may be used within an electrode assembly, resulting in a fixed alignment between the anode and cathode. Anode current collectors and cathode current collectors may be interleaved with the co-coated separator elements to enable transfer of the current to an environment outside the electrode assembly. The co-coated separator elements may be cut from a web of co-coated separator material, the anode current collectors may be cut from a web of anode current collector material, and the cathode current collectors may be cut from a web of cathode current collector material.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method for preparing an electrode assembly, the method comprising:
coating a first surface of a web of ionically permeable and electrically isolating separator material with cathodically active material;
coating a second surface of the web of separator material, opposite the first surface, with anodically active material;
dividing the web of separator material, having the coating of cathodically active material on the first surface and the coating of anodically active material on the second surface, into a plurality of co-coated separator elements;
stacking the co-coated separator elements with anode current collectors and cathode current collectors wherein:
the anode-coated side of a first co-coated separator element is facing the anode-coated side of a second co-coated separator element;
the cathode-coated side of the second co-coated separator element is facing the cathode-coated side of a third co-coated separator element;
an anode current collector is located between, and in physical contact with, the anode-coated sides of the first and second co-coated separator elements; and
a cathode current collector is located between, and in physical contact with, the cathode-coated sides of the second and third co-coated separator elements.

2. The method of claim 1, wherein dividing the web of separator material into the plurality of co-coated separator elements comprises cutting the web of separator material into the plurality of co-coated separator elements.

3. The method of claim 1, wherein:
coating the first surface of the web of separator material with the cathodically active material includes performing one of chemical vapor deposition (CVD), physical vapor deposition (PVD), atomic layer deposition (ALD), slot-die coating, comma coating, or sputter coating; and
coating the second surface of the web of separator material with the anodically active material includes performing one of chemical vapor deposition (CVD), physical vapor deposition (PVD), atomic layer deposition (ALD), slot-die coating, comma coating, or sputter coating.

4. The method of claim 1, wherein a dimension of the anodically active material in a direction transverse to which the coating occurs is greater than a dimension of the cathodically active material in a direction transverse to which the coating occurs.

5. The method of claim 1, further comprising:
laser dicing a web of cathode current collector material into a plurality of cathode current collectors; and
cleaning the plurality of cathode current collectors.

6. The method of claim 1, further comprising:
laser dicing a web of anode current collector material into a plurality of anode current collectors; and
cleaning the plurality of anode current collectors.

7. The method of claim 1, wherein the stacking the co-coated separator elements with anode current collectors and cathode current collectors comprises:
stacking cathode current collectors that comprise a material that is electrochemically compatible with the cathodically active material and;
stacking anode current collectors that comprise a material that is electrochemically compatible with the anodically active material.

8. The method of claim 7, wherein stacking cathode current collectors that comprise a material that is electrochemically compatible with the cathodically active material comprises stacking cathode current collectors comprising nickel-coated copper, nickel, stainless steel, or aluminum.

9. The method of claim 7, wherein stacking anode current collectors that comprise a material that is electrochemically compatible with the anodically active material comprises stacking anode current collectors comprising nickel-coated copper, nickel, stainless steel, or aluminum.

10. An electrode structure for a battery comprising:
a plurality of co-coated wave pairs comprising ionically permeable and electrically isolating separator material that is coated on a first side with cathodically active material and is coated on a second side, opposite the first side, with anodically active material;
a plurality of anode current collectors; and
a plurality of cathode current collectors; wherein:
the anode-coated side of a first wave pair is facing the anode-coated side of a second wave pair;
the cathode-coated side of the second wave pair is facing the cathode-coated side of a third wave pair;
an anode current collector is located between, and in physical contact with, the anode-coated sides of the first and second wave pairs; and
a cathode current collector is located between, and in physical contact with, the cathode-coated sides of the second and third wave pairs.

11. The electrode structure of claim 10, wherein the alignment of the cathodically active material coated on the first side of the separator material to the anodically active material coated on the second side of the separator material is fixed.

12. The electrode structure of claim 10, wherein:
the first side of the web of separator material is coated with the cathodically active material by performing one of chemical vapor deposition (CVD), physical vapor deposition (PVD), atomic layer deposition (ALD), slot-die coating, comma coating, or sputter coating; and
the second surface of the web of separator material is coated with the anodically active material by performing one of chemical vapor deposition (CVD), physical vapor deposition (PVD), atomic layer deposition (ALD), slot-die coating, comma coating, or sputter coating.

13. The electrode structure of claim 10, wherein a dimension of the anodically active material in a direction transverse to which the coating occurs is greater than a dimension of the cathodically active material in a direction transverse to which the coating occurs.

13. The electrode structure of claim 10, wherein the plurality of cathode current collectors are cleaned prior to being incorporated into the electrode structure.

14. The electrode structure of claim 10, wherein the plurality of anode current collectors are cleaned prior to being incorporated into the electrode structure.

15. The electrode structure of claim 10, wherein:
the cathode current collectors comprise a material that is electrochemically compatible with the cathodically active material and;
the anode current collectors comprise a material that is electrochemically compatible with the anodically active material.

16. The electrode structure of claim 15, wherein the cathode current collectors comprise nickel-coated copper, nickel, stainless steel, or aluminum.

17. The electrode structure of claim 15, wherein the anode current collectors comprise nickel-coated copper, nickel, stainless steel, or aluminum.

18. A battery comprising a battery enclosure, and an electrode assembly and an electrolyte within the battery enclosure, wherein:
the electrode assembly comprises:
a plurality of co-coated wave pairs comprising ionically permeable and electrically isolating separator material that is coated on a first side with cathodically active material and is coated on a second side, opposite the first side, with anodically active material;
a plurality of anode current collectors; and
a plurality of cathode current collectors; wherein:
the anode-coated side of a first wave pair is facing the anode-coated side of a second wave pair;
the cathode-coated side of the second wave pair is facing the cathode-coated side of a third wave pair;
an anode current collector is located between, and in physical contact with, the anode-coated sides of the first and second wave pairs; and
a cathode current collector is located between, and in physical contact with, the cathode-coated sides of the second and third wave pairs.

19. The battery of claim 18, further comprising an electrode constraint to at least partially restrain growth of the electrode assembly in the longitudinal direction upon cycling of the secondary battery between the charged and discharged states

20. The battery of claim 19, wherein:
the cathode current collectors comprise a material that is electrochemically compatible with the cathodically active material and;
the anode current collectors comprise a material that is electrochemically compatible with the anodically active material.
